(19) United States
(12) Patent Application Publication
(10) Pub. No.: US 2023/0407013 A1
(43) Pub. Date: Dec. 21, 2023

(54) TITANIUM-BASED COMPOUNDS AND THEIR APPLICATIONS

(71) Applicant: DOW SILICONES CORPORATION, Midland, MI (US)

(72) Inventor: Frederic GUBBELS, Seneffe (BE)

(21) Appl. No.: 18/036,042

(22) PCT Filed: Nov. 16, 2021
(86) PCT No.: PCT/US2021/059443

§ 371 Date: May 9, 2023

Related U.S. Application Data
(60) Provisional application No. 63/114,723, filed on Nov. 17, 2020.

(51) Int. Cl. C08G 77/58; C08G 77/16; C08G 77/08

(52) U.S. Cl. CPC C08G 77/58; C08G 77/16; C08G 77/08

(57) ABSTRACT

A process for the preparation of a titanium-based reaction product is provided. The titanium-based reaction product comprises the reaction product of an alkoxy titanium compound and a silanol terminated polydiorganosiloxane. The polydiorganosiloxane typically has at least two silanol groups per molecule. The titanium-based reaction product is also described, as is its use as a catalyst, having improved stability in the presence of water, for condensation curable silicone compositions. The titanium-based reaction product may additionally at least partially replace the need for a separate polymer to be used in the condensation curable silicone compositions.

This case relates to a process for the preparation of a titanium-based reaction product of an alkoxy titanium compounds and silanol terminated polydiorganosiloxanes having at least one but typically at least two silanol groups per molecule wherein the reaction product may be used as a catalyst, having improved stability in the presence of water, for condensation curable silicone compositions but additionally may at least partially replace the need for a separate polymer to be used in the condensation curable silicone compositions.

It is well known to those skilled in the art that alkoxy titanium compounds, i.e., alkyl titanates, are suitable catalysts for one component moisture curable silicone compositions (References: Noll, W.; Chemistry and Technology of Silicones, Academic Press Inc., New York, 1968, p. 399, and Michael A. Brook, silicon in organic, organometallic and polymer chemistry, John Wiley & sons, Inc. (2000), p. 285). Titanate catalysts have been widely described for their use to formulate skin or diffusion cured one-part condensation curing silicone elastomers. These formulations are typically available in one-part packages that are applied in a layer that is thinner than 15 mm. Layers thicker than 15 mm are known to lead to uncured material in the depth of the material, because the moisture is very slow to diffuse in very deep sections. Skin or diffusion cure (e.g., moisture/condensation) takes place when the initial cure process takes place by the formation of a cured skin at the composition/air interface subsequent to the sealant/encapsulant being applied on to a substrate surface. Subsequent to the generation of the surface skin the cure speed is dependent on the speed of diffusion of moisture from the sealant/encapsulant interface with air to the inside (or core), and the diffusion of condensation reaction by-product/effluent from the inside (or core) to the outside (or surface) of the material and the gradual thickening of the cured skin over time from the outside/surface to the inside/core.

Multi component compositions designed to activate condensation cure in the bulk of the product (bulk cure), until recently, have not used titanium-based catalysts in or as curing agents. Hence, other catalysts such as tin or zinc-based catalysts, e.g., dibutyl tin dilaurate, tin octoate and/or zinc octoate are generally used (Noll, W.; Chemistry and Technology of Silicones, Academic Press Inc., New York, 1968, p. 397). In silicone compositions stored before use in two or more parts, one part usually contains a filler which typically contains the moisture required to activate condensation cure in the bulk of the product Unlike the previously mentioned diffusion cure one-part system, two-part condensation cure systems, once mixed together, enable bulk cure even in sections greater than 15 mm in depth. In this case the composition will cure (subsequent to mixing) throughout the material bulk. If a skin is formed, it will be only in the first minutes after application. Soon after, the product will become a solid in the entire mass.

Until recently, titanate catalysts i.e. tetra alkyl titanates (e.g. Ti(OR)₄ where R is an alkyl group having at least one carbon) and chelated titanates were not used for curing two part condensation curable compositions because it was well known that they are sensitive to hydrolysis (e.g. the cleavage of bonds in functional groups by reaction with water) or alcoholysis in presence of water or alcohol respectively. Unfortunately, titanium compounds of this type quickly react and liberate the corresponding alcohol that is bound to the titanium. For example, in the presence of moisture, tetra alkyl titanate catalysts can fully hydrolyse to form titanium (IV) hydroxide (Ti(OH)₄), which is of only limited solubility in silicone-based compositions. Crucially, the formation of titanium hydroxides such as titanium (IV) hydroxide can dramatically negatively affect their catalytic efficiency towards curing condensation curable silicone compositions, leading to uncured or at best only partially cured systems. This issue is not seen with Tin (IV) catalysts because they are not similarly affected by e.g., water contained in the filler present in one of the parts of the product. resulting in the historic understanding that such two-part condensation curable compositions require tin catalysts.

Recently contrary to historical expectations it has been found that in some instances titanium-based catalysts may be utilised as or in curing agents for multi-part, e.g., two-part, compositions designed for condensation “bulk cure” of silicone-based compositions (e.g. WO2016120270, WO2018024858 and WO2019027668). This is helpful to many users because tin cured condensation systems undergo reversion (i.e., depolymerisation) at temperatures above 80° C. and as such the use of tin (IV) catalysts are not desired for several applications especially where cured elastomers are going to be exposed to heat e.g., electronics applications. After much study it is currently believed that there are three specific requirements which have to be met when using titanates for catalyzing two-part condensation cure elastomers with cross-linkers containing alkoxy groups.

For titanate catalysts to be used to cure two-part compositions designed for bulk cure (i.e. where a thick section of product is required (>15 mm)) in replacement for tin (iv) catalysts the composition must be designed to bulk cure i.e. to substantially avoid diffusion cure, avoid immediate gelling when the two parts of a two part composition are mixed together and ensure that the titanium catalyst does not react with water present in the composition (e.g. water contained in fillers) to form titanium (IV) hydroxide (Ti(OH)₄). These requirements have been achieved but in doing so the gel time of two-part bulk curable silicone elastomer compositions utilising titanate catalysts is slower than for tin (iv) cured systems which is limiting the applications for which the two-part bulk curable silicone elastomer compositions may be used.

Hence, there is a need to identify suitable titanium-based reaction products which have improved hydrolytic stability (i.e., are not deactivated in the presence of water and/or alcohols) and which may be used as titanium-based catalysts.

There is provided a method for the preparation of a titanium-based reaction product comprising the steps of:
(i) mixing a first ingredient, an alkoxy titanium compound having from 2 to 4 alkoxy groups with a second ingredient, a linear or branched polydiorganosiloxane having at least two terminal silanol groups per molecule and a viscosity of from 30 to 300 000 mPa·s at 25° C.;
(ii) enabling the first and second ingredients to react together by stirring under vacuum to form a reaction product; and
(iii) collecting the reaction product of step (ii).

There is also provided herein a titanium-based reaction product which is the reaction product of the method hereinbefore described.

There is also provided herein a titanium-based reaction product obtained or obtainable by a method comprising the steps of:
(i) mixing a first ingredient, an alkoxy titanium compound having from 2 to 4 alkoxy groups with a second ingredient, a linear or branched polydiorganosiloxane having at least two terminal silanol groups per molecule and a viscosity of from 30 to 300 000 mPa·s at 25° C.;
(ii) enabling the first and second ingredients to react together by stirring under vacuum to form a reaction product; and
(iii) collecting the reaction product of step (ii).

There is also provided herein the use of a titanium-based reaction product obtained or obtainable from the process described above as a catalyst for curing condensation curable silicone compositions.

The first ingredient of the process described herein is an alkoxy titanium compound having from 2 to 4 alkoxy groups, e.g. Ti(OR)₄, Ti(OR)₃R¹, Ti(OR)₂R¹₂ or a chelated alkoxy titanium molecule where there are two alkoxy (OR) groups present and a chelate bound twice to the titanium atom; where R is a linear or branched alkyl group having from 1 to 20 carbons, alternatively 1 to 15 carbons, alternatively 1 to 10 carbons, alternatively 1 to 6 carbons and when present R¹ is an organic group such as an alkyl group having from 1 to 10 carbon atoms, an alkenyl group having from 2 to carbon atoms, an alkynyl group having from 2 to 10 carbon atoms, a cycloalkyl group having from 3 to 10 carbon atoms, or a phenyl group having from 6 to 20 carbon atoms or a mixture thereof.

Each R¹ may optionally contain substituted groups with e.g., one or more halogen group such as chlorine or fluorine. Examples of R¹ may include but are not restricted to methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. However, typically each R¹ may be the same or different and is selected from an alkyl group, an alkenyl group or an alkynyl group, alternatively an alkyl group, an alkenyl group, alternatively an alkyl group, in each case having up to 10 carbons, alternatively, up to 6 carbons per group.

As mentioned above R is a linear or branched alkyl group having from 1 to 20 carbons, include but are not restricted to methyl, ethyl, n-propyl, isopropyl, n-butyl, tertiary butyl branched secondary alkyl groups such as 2, 4-dimethyl-3-pentyl. Suitable examples of the first ingredient when Ti(OR)₄, include for the sake of example, tetra methyl titanate, tetra ethyl titanate, tetra n-propyl titanate, tetra n-butyl titanate, tetra t-butyl titanate, tetraisopropyl titanate. When the first ingredient is Ti(OR)₃R¹, R¹ is typically an alkyl group and examples include but are not limited to trimethoxy alkyl titanium, triethoxy alkyl titanium, tri n-propoxy alkyl titanium, tri n-butoxy alkyl titanium, tri t-butoxy alkyl titanium and tri isopropoxy alkyl titanate.

The first ingredient, i.e., the alkoxy titanium compound having from 2 to 4 alkoxy groups, maybe present in an amount of from 0.01 wt. % to 20 wt. % of the total weight of the First ingredient+second ingredient.

The second ingredient is a linear or branched polydiorganosiloxane having at least two terminal silanol groups per molecule. The second ingredient may comprise an oligomer or polymer comprising multiple siloxane units of formula (1)

—(R²ₛSiO_{(4-s/2)})— (1)

in which each R² is independently an organic group such as a hydrocarbyl group having from 1 to 10 carbon atoms optionally substituted with one or more halogen group such as chlorine or fluorine and s is 0, 1 or 2. In one alternative s is 2 and the linear or branched polydiorganosiloxane backbone is therefore linear although a small proportion of groups where s is 1 may be utilised to enable branching. For example, R² may include alkyl groups such as methyl, ethyl, propyl, butyl, alkenyl groups such as vinyl, propenyl, butenyl, pentenyl and or hexenyl groups, cycloalkyl groups such as cyclohexyl, and aromatic groups such as phenyl, tolyl group. In one alternative, R² may comprise alkyl groups, alkenyl groups and/or phenyl groups such as methyl, ethyl, propyl, butyl, alkenyl groups such as vinyl, propenyl, butenyl, pentenyl and or hexenyl groups, cycloalkyl groups such as cyclohexyl, and aromatic groups such as phenyl, tolyl group. Preferably, the polydiorganosiloxane chain is a polydialkylsiloxane chain, a polyalkylalkenylsiloxane chain or a polyalkylphenylsiloxane chain but co-polymers of any two or more of these may also be useful. When the second ingredient contains a polydialkylsiloxane chain, a polyalkylalkenylsiloxane chain and/or a polyalkylphenylsiloxane chain, the alkyl groups usually comprises between 1 and 6 carbons; alternatively the alkyl groups are methyl and/or ethyl groups, alternatively the alkyl groups are methyl groups; the alkenyl groups usually comprises between 2 and 6 carbons; alternatively the alkenyl groups may be vinyl, propenyl, butenyl, pentenyl and or hexenyl groups, alternatively vinyl, propenyl, and/or hexenyl groups. In one alternative the polydiorganosiloxane is a polydimethylsiloxane chain, a polymethylvinylsiloxane chain or a polymethylphenylsiloxane chain, or a copolymer of two or all of these.

For the avoidance of doubt a polydiorganosiloxane polymer means a substance composed of a molecule of high molecular weight (generally having a number average molecular weight of greater than or equal to 10,000 g/mol comprising a large number of —(R²ₛSiO_{(4-s)/2})— units which show polymer-like properties and the addition or removal of one or a few of the units has a negligible effect on the properties, in contrast a polydiorganosiloxane oligomer is a compound with a regular repeating structure —(R²ₛSiO_{(4-s)/2})— units having too low an average molecular weight e.g., a molecule consisting of a few monomer units. e.g., dimers, trimers, and tetramers are, for example, oligomers respectively composed of two, three, and four monomers.

When linear, each terminal group must contain one silanol group. For example, the polydiorganosiloxane maybe dialkylsilanol terminated, alkyl disilanol terminated or trisilanol terminated but is preferably dialkylsilanol terminated. When branched the second ingredient must have at least two terminal silanol (Si—OH) bonds per molecule and as such comprise at least two terminal groups which are dialkylsilanol groups, alkyl disilanol groups and/or trisilanol groups, but typically dialkylsilanol groups.

Typically the second ingredient will have a viscosity in the order of 30 to 300 000 mPa·s, alternatively 50 to 100 000 mPa·s at 25° C., alternatively 70 to 75,000 mPa·s at 25° C., alternatively 70 to 50,000 mPa·s at 25° C., alternatively 70 to 20,000 mPa·s at 25° C., alternatively 70 to 10,000 mPa·s at 25° C. The viscosity may be measured using any suitable means e.g., a Modular Compact Rheometer (MCR) 302 from Anton Paar GmbH of Graz, Austria using the most suitable settings and plates for the viscosity concerned, for example using a 25 mm diameter rotational plate with a gap of 0.3 mm at a shear rate of is −1 s⁻¹.

The number average molecular weight (Mn) and weight average molecular weight (Mw) of silicone can also be determined by Gel permeation chromatography (GPC) using polystyrene calibration standards. This technique is a standard technique, and yields values for Mw (weight average), Mn (number average) and polydispersity index (PI) (where PI=Mw/Mn).

Mn value provided in this application have been determined by GPC and represent a typical value of the polydiorganosiloxane used. If not provided by GPC, the Mn may also be obtained from calculation based on the dynamic viscosity of said polydiorganosiloxane.

The reaction as hereinbefore described may be undertaken at any suitable temperature but typically commences at room temperature. The temperature may elevate during the reaction and/or stirring and if desired the ingredients may be heated during the reaction.

The reaction takes place under vacuum with a view to removing at least 50 wt. %, alternatively at least 75 wt. % alternatively at least 90% of the total amount of alcoholic by-products generated during the reaction. The above may be determined via several analytical techniques of which the simplest is the determination of weight loss from the titanium-based reaction product.

Without being tied to current understanding, it is believed that the main titanium-based reaction products of the above reaction when the first ingredient is Ti(OR)₄, is a mixture of

(RO)ₙTi((OSiR²₂)ₘ—OH)₄₋ₙ (2)

Where n is 0, 1 or 2, alternatively 0 or 1, but preferably the major product is where n is 0, i.e.

Ti((OSiR²₂)ₘ—OH)₄ (3)

Where m is the degree of polymerisation of the second ingredient and is an integer indicative (commensurate) of the viscosity thereof.

Similarly when the first ingredient is substantially Ti(OR)₃R¹, it is believed that the main titanium-based reaction products of the above reaction when a is 0 or 1, is

R¹(RO)ₙTi((OSiR²₂)ₘ—OH)₃₋ₐ (4)

but preferably the major product is where a is 0, i.e.

R¹Ti((OSiR²₂)ₘ—OH)₃ (5)

Where m the number average degree of polymerisation of the second ingredient and is an integer indicative (commensurate) of the viscosity of the second ingredient.

Optionally, there may be a third ingredient present. When present, the third ingredient is a linear or branched polydiorganosiloxane and may be an oligomer or polymer as described for the second ingredient. However, the third ingredient only has one terminal silanol group per molecule for use in the reaction described above to form a Si—O—Ti bond with the first ingredient. The other terminal groups of the third ingredient contain no silanol groups. The terminal groups containing no silanol groups may comprise R² groups as defined above, alternatively a mixture of alkyl and alkenyl R² groups, alternatively alkyl R² groups. Examples include trialkyl termination e.g., trimethyl or triethyl termination or dialkylalkenyl termination, e.g., dimethylvinyl or diethyl vinyl or methylethylvinyl termination or the like.

Typically the third ingredient will also have a viscosity analogous to that of the second ingredient, in the order of 30 to 300 000 mPa·s, alternatively 50 to 100 000 mPa·s at 25° C., alternatively 70 to 75,000 mPa·s at 25° C., alternatively 70 to 50,000 mPa·s at 25° C., alternatively 70 to 20,000 mPa·s at 25° C., alternatively 70 to 10,000 mPa·s at 25° C. The viscosity may be measured using any suitable means e.g., a Modular Compact Rheometer (MCR) 302 from Anton Paar GmbH of Graz, Austria using the most suitable settings and plates for the viscosity concerned, for example using a 25 mm diameter rotational plate with a gap of 0.3 mm at a shear rate of 1 s⁻¹.

The third ingredient may be present in an amount of up to 75 wt. % of the combination of the weight of the first, second and third ingredients, whereby the third ingredient replaces the equivalent proportion of the second ingredient. However, preferably the third ingredient when present is present in an amount of no more than 50%, alternatively no more than 25% of the first, second and if present the third ingredients. When the third ingredient is present one or more-silanol groups in structures (2), (3), (4) or (5) may be replaced by an R² group, alternatively an alkyl group or an alkenyl group, alternatively an alkyl group. For example, in the case of structure (2) the titanium-based reaction product maybe that shown below in structure (2a):

(RO)ₙTi((OSiR²₂)ₘ—R²)ₚ((OSiR²₂)ₘ—OH)₄₋ₙ₋ₚ (2a)

Where n is 0, 1 or 2, alternatively 0 or 1, p is 0, 1 or 2, alternatively 0 or 1, and n+p is less than or equal to 4 and m is as defined above.

In the present process it is preferred not to include the third ingredient as a reactant for the process as when catalysts of the type depicted in structures (2), (3), (4) or (5) are present, the terminal silanol groups are potentially available for participation in the formation of the cured silicone network, which makes them useful in the fully formulated elastomers. This is clearly less likely to be the case when greater amounts of the third ingredient are used as a starting ingredient in the process to make the catalysts herein. However, the presence of some of the third ingredient in the starting materials may be useful to assist in obtaining the required modulus of elastomers cured using the product of the process described herein.

When the starting ingredients in the process are the first and second ingredients, the molar ratio of silanol groups: titanium may be any suitable ratio equal to or greater than 2:1. However, is preferred for the ratio to be within the range of from 5:1 to 15:1 alternatively from 7:1 to 15:1, alternatively from at least 8:1 to 11:1. Lower ratios seem to lead to the presence of more viscous titanium-based reaction product and less first ingredient present resulting in slower gelling times.

The total silanol molar content is calculated for 100 g of first and second ingredients. The silanol molar content related to the second ingredient is equal to the amount in grams (g) of silanol containing polymer in 100 g of the first and second ingredients divided by the number average molecular weight of the second ingredient multiplied by the average number of silanol functions present in the second ingredient, typically 2. If there are several silanol functional linear or branched polydiorganosiloxanes in the starting ingredients, the sum of the molar content of each polymer is determined and then the cumulative total from all the linear or branched polydiorganosiloxanesis added together to constitute the total silanol molar content in the formulation.

The molar amount of any starting ingredient was determined using the following calculation:

[Weight in Parts of the Ingredient×100]

[Sum of all Parts of the Starting Ingredients×MW of the Ingredient]

Hence, merely for example, when ingredient 1 is tetra n-butyl titanate (TnBT), if ingredient 1 and ingredient 2 were mixed in a weight ratio of 10:1, i.e., 10 parts of ingredient 2 to every one part by weight of ingredient 1, given the molecular weight of TnBT is 340; the calculation would be:

[Weight in parts of TnBT(1)×100]

[sum of all parts of the starting ingredients (11)×340]=0.0267 mole of catalyst per 100 g of the composition.

In one embodiment, the first ingredient is added to the second ingredient, or when the third ingredient is present, the first ingredient is added to a mixture of the second and third ingredients.

In an alternative embodiment, the second ingredient may be introduced into the first ingredient. This embodiment is less convenient than the above because titanates of the type used as the first ingredient, from which volatile alcohols (R—OH) are generated in accordance with chemical reactions (6) below, are generally flammable due to the moisture from environment because it will substantially always contain some alcohol residues. The flash point of the titanium catalyst depends on the alcohol flammability.

Ti—OR+H₂O(moisture from the air)->Ti-OH+R—OH

Ti—OR+Si—OH—>Ti—O—Si+R—OH (6)

Hence, this method will require an explosion proof manufacturing process and the second ingredient is introduced into the first ingredient in a gradual measured manner. This route is likely to lead, at least initially, to a more concentrated catalyst until gradually the content of the second ingredient is increased. This embodiment is also less favoured because it is more difficult to remove the alcoholic by-products as successfully and the content of the second ingredient is generally much larger than the first ingredient in weight and volume.

It was found however that there was no need for complicated separation techniques to be used to isolate specific titanium species as the titanium-based reaction product works very well without separation as a catalyst for condensation curable two-part silicone elastomer compositions. As a consequence, analysis indicates that rather than a single compound the titanium-based reaction product herein is a mixture of several compounds. Typically, the viscosity of the titanium-based reaction product ranges from 500 and 1,000,000 mPa·s, alternatively 500 to 750,000 mPa·s, alternatively 500 to 500,000 mPa·s, alternatively 500 to 300,000 mPa·s. The viscosity may be measured using any suitable means e.g., a Modular Compact Rheometer (MCR) 302 from Anton Paar GmbH of Graz, Austria using the most suitable settings and plates for the viscosity concerned, for example using a 25 mm diameter rotational plate with a gap of 0.3 mm at a shear rate of 1 s⁻¹.

It is usually the case that equivalent zirconium compounds also function as catalysts for condensation curable silicone elastomer compositions but in this instance, it was surprisingly identified that equivalent zirconium products failed to function in the same manner as catalysts for condensation curable silicone elastomer compositions in particular for two-part silicone elastomer compositions.

The main advantage of the titanium-based reaction product resulting from the process described herein has significantly improved hydrolytic stability, i.e., it is storage stable, in standard airtight packaging for months and even for several weeks when exposed to ambient air. In comparison standard titanate catalysts, such as the first ingredient as described above, when in liquid form and exposed to atmospheric moisture gradually turns into a solid resinous material within a few hours of exposure. Furthermore, when in use as a catalyst in or as a curing agent for a two-part silicone sealant composition when mixed with sealant composition components containing water the titanium-based reaction product herein remains stable for several months.

Hence, this disclosure additionally teaches the use of a titanium-based reaction product as hereinbefore described as a catalyst for a condensation curable silicone elastomer composition and the use of a titanium-based reaction product as hereinbefore described as a silicone polymer and catalyst, e.g., in or as a curing agent in a condensation curable silicone elastomer composition. This will be appreciated from the following examples.

Condensation curable silicone compositions generally comprise a minimum of three ingredients:
(i) Silicone polymer, typically for example a molecule analogous to the second ingredient as described herein;
(ii) A cross-linker molecule which is designed to cross-link the polymer during the curing process to form a cross-linked network creating a cured gel-like and/or elastomeric material
(iii) A catalyst, e.g., a tin (iv) compound or a titanate as defined as ingredient (i) herein.
   Depending on the intended end use such compositions may comprise a wide variety of additives which can adjust the properties of the cured material when present.

It is also to be appreciated that the titanium-based reaction product herein not only appears to render the catalytic nature of the titanium molecules more hydrolytically stable (stable to water) but also because the starting ingredient generally has at least two silanol groups per molecule the titanium-based reaction product has Si—O—Ti or silanol groups (Si—OH) available for reaction into the cured product. Hence, when utilised as a catalyst for curing condensation curable silicone compositions the reaction product of the process herein may function as both catalyst agent and polymer as will be identified in a some of the following examples.

### EXAMPLES

All viscosity measurements were made using a Modular Compact Rheometer (MCR) 302 from Anton Paar GmbH of Graz, Austria using a 25 mm diameter rotational plate with a gap of 0.3 mm at a shear rate of 1 s⁻¹. All viscosities were measured at 25° C. unless otherwise indicated. Silanol (Si—OH)/Ti molar ratio values given were calculated using the method described above. When vacuum was applied during the process, a vacuum of about 160 mbar (16 kPa) was applied. Where appropriate the mixer lids were pierced with 5 small holes to help the volatile compounds to leave the mixture.

### Example 1

200 g of dimethylsilanol terminated polydimethylsiloxane having a viscosity of 2,163 mPa·s at 25° C. was introduced into a plastic receptacle of a DAC 600 FVZ/VAC-P type SpeedMixer™ from Hauschild.

0.497 g of tetraisopropoxy titanium was then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for:
2 minutes at 2350 rpm at atmospheric pressure and then
2 minutes at 2350 rpm under vacuum and then
left 6 minutes under vacuum without mixing.
This procedure was repeated, i.e., the ingredients were mixed again for a further
2 minutes at 2350 rpm at atmospheric pressure and then a further 2 minutes at 2350 rpm under vacuum and finally were left for a further period of 6 minutes under vacuum without mixing.

After completion of the above mixing regime the receptacle, lid and resulting reaction product, were re-weighed to determine weight loss due to the extraction of volatile alcohols.
Initial weight was 277.005 g
Final weight was 276.576 g
Weight loss=0.429 g
The resulting loss of 0.429 g in weight accounts for approximately 100% of the alcohol content extractable as a by-product of the reaction between the tetraisopropoxy titanium (the first ingredient) and the dimethylsilanol terminated polydimethylsiloxane (second ingredient). The calculated Si—OH/Ti molar ratio was about 10.4, assuming a number average molecular weight of the polymer of about 22,000 g/mol.

The viscosity of the titanium-based reaction product generated via the above process was determined to be 47,338 mPa·s using a Modular Compact Rheometer (MCR) 302 from Anton Paar GmbH of Graz, Austria with a 25 mm diameter rotational plate with a gap of 0.3 mm at a shear rate of 1 s⁻¹.

The titanium-based reaction product was then stored at room temperature in a glass bottle for a period of 28 days before the viscosity was re-measured using the same testing protocol and was found to have remained pretty constant with a minor increase to 48,856 mPa·s.

### Example 2

200 g of dimethylsilanol terminated polydimethylsiloxane having a viscosity of 2,163 mPa·s at 25° C. was introduced into a plastic receptacle of a DAC 600 FVZ/VAC-P type SpeedMixer™ from Hauschild.

0.592 g of tetraisopropoxy titanium was then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for
2 minutes at 2350 rpm at atmospheric pressure and then
2 minutes at 2350 rpm under vacuum and then
left 6 minutes under vacuum without mixing.
This procedure was repeated, i.e., the ingredients were mixed again for a further 2 minutes at 2350 rpm at atmospheric pressure and then a further 2 minutes at 2350 rpm under vacuum and finally were left for a further period of 6 minutes under vacuum without mixing.

After completion of the above mixing regime, the receptacle, lid and resulting reaction product, were re-weighed to determine weight loss due to the extraction of volatile alcohols.
Initial weight was 277.058 g
Final weight was 276.589 g
Weight loss=0.469 g

The resulting loss of 0.469 g in weight accounts for approximately 94% of the alcohol content extractable as a by-product of the reaction between the tetraisopropoxy titanium (the first ingredient) and the dimethylsilanol terminated polydimethylsiloxane (second ingredient). The calculated Si—OH/Ti molar ratio was about 8.7:1 assuming a number average molecular weight of the polymer of about 22,000.

The viscosity of the titanium-based reaction product generated via the above process was determined to be 211,700 mPa·s using a Modular Compact Rheometer (MCR) 302 from Anton Paar GmbH of Graz, Austria with a 25 mm diameter rotational plate with a gap of 0.3 mm at a shear rate of 1 s⁻¹.

The titanium-based reaction product was then stored at room temperature in a glass bottle for a period of 28 days before the viscosity was re-measured using the same testing protocol is and was found to have remained pretty constant with a minor increase to 208,190 mPa·s.

Example 2 is showing that at a Si—OH/Ti ratio below 10, the viscosity of the mixture is greater but there is no problem preparing the titanium-based reaction product.

### Example 3

200 g of dimethylsilanol terminated polydimethylsiloxane having a viscosity of 70 mPa·s at was introduced into a plastic receptacle of a DAC 600 FVZ/VAC-P type SpeedMixer™ from Hauschild.

3.5 g of tetraisopropoxy titanium was then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for 10 minutes at 2350 rpm under vacuum and then this mixing step was undertaken a further seven times.

After completion of the above mixing regime the resulting reaction product, receptacle and lid were re-weighed to determine weight loss due to the extraction of volatile alcohols.
Initial weight was 280.082 g
Final weight was 277.481 g.
Weight loss=2.601 g
The resulting loss of 2.601 g in weight again accounts for approximately 88% of the alcohol content extractable as a by-product of the reaction between the tetraisopropoxy titanium (the first ingredient) and the dimethylsilanol terminated polydimethylsiloxane (second ingredient). The calculated Si—OH/Ti molar ratio is about 10.3:1, assuming a number average molecular weight of the polymer of about 3,168.

The viscosity of the titanium-based reaction product generated via the above process was determined to be 617 mPa·s using a Modular Compact Rheometer (MCR) 302 from Anton Paar GmbH of Graz, Austria with a 25 mm diameter rotational plate with a gap of 0.3 mm at a shear rate of 1 s⁻¹.

The titanium-based reaction product was then stored at room temperature in a glass bottle for a period of 28 days before the viscosity was re-measured using the same testing protocol is and was found to have remained pretty constant at 597 mPa·s.

Example 3 is showing that a lower viscosity second ingredient can be used successfully and will lead to a lower viscosity reaction product, which can be useful for easy dispensing.

### Example 4

200 g of dimethylsilanol terminated polydimethylsiloxane having an average viscosity of 803 mPa·s at 25° C. was introduced into a plastic receptacle of a DAC 600 FVZ/VAC-P type SpeedMixer™ from Hauschild.
0.8 g of tetraisopropoxy titanium were then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for
6 minutes at 2350 rpm under vacuum and then this mixing step was undertaken a further four times.

After completion of the above mixing regime the resulting reaction product, receptacle and lid were re-weighed to determine weight loss due to the extraction of volatile alcohols.
Initial weight was 277.179 g
Final weight was 276.604 g.
Weight loss=0.575 g
The resulting loss of 0.575 g in weight again accounts for approximately 85% of the alcohol content extractable as a by-product of the reaction between the titanate catalyst (the first ingredient) and the linear or branched polydiorganosiloxane (second ingredient). The calculated Si—OH/Ti molar ratio is about 9.6:1 assuming an average molecular weight of the polymer of about 14,800.

The viscosity of the titanium-based reaction product generated via the above process was determined to be 20,237 mPa·s using a Modular Compact Rheometer (MCR) 302 from Anton Paar GmbH of Graz, Austria with a 25 mm diameter rotational plate with a gap of 0.3 mm at a shear rate of 1 s⁻¹.

The titanium-based reaction product was then stored at room temperature in a glass bottle for a period of 28 days before the viscosity was re-measured using the same testing protocol is and was found to have remained pretty constant with a minor increase to 24,505 mPa·s.

### Example 5

200 g of dimethylsilanol terminated polydimethylsiloxane having a viscosity of 2,163 mPa·s at 25° C. was introduced into a plastic receptacle of a DAC 600 FVZ/VAC-P type SpeedMixer™ from Hauschild.

0.51 g of tetra n-butoxy titanium were then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for
2 minutes at 2350 rpm at atmospheric pressure and then
2 minutes at 2350 rpm under vacuum and then
left 6 minutes under vacuum without mixing.
This procedure was repeated 4 times, i.e., the ingredients were mixed again for a further 2 minutes at 2350 rpm at atmospheric pressure and then a further 2 minutes at 2350 rpm under vacuum and finally were left for a further period of 6 minutes under vacuum without mixing.

After completion of the above mixing regime the resulting reaction product, receptacle and lid were re-weighed to determine weight loss due to the extraction of volatile alcohols.
Initial weight was 277.01 g
Final weight was 276.6 g
Weight loss=0.41 g
The resulting loss of 0.41 g in weight accounts for approximately 95.2% of the alcohol content extractable as a by-product of the reaction between the titanate catalyst (the first ingredient) and the linear or branched polydiorganosiloxane (second ingredient).

The viscosity of the titanium-based reaction product generated via the above process was determined to be 54245 mPa·s using a Modular Compact Rheometer (MCR) 302 from Anton Paar GmbH of Graz, Austria with a 25 mm diameter rotational plate with a gap of 0.3 mm at a shear rate of 1 s⁻¹.

The titanium-based reaction product was then stored at room temperature in a glass bottle for a period of 28 days before the viscosity was re-measured using the same testing protocol is and was found to have increased to 67132 mPa·s.

### Example 6

In this example the titanium-based reaction product was successfully prepared using the less preferred option of introducing the second ingredient into the first ingredient.

59.088 g of tetra n butoxy titanium was introduced into a plastic receptacle of a DAC 600 FVZ/VAC-P type SpeedMixer™ from Hauschild. Then 267.339 g of OH terminated polydimethylsiloxane (viscosity of 70 mPa·s @ 25° C.) were added and mixed for 3 times 2 minutes under vacuum at 2300 rpm.

15 g of the here above product was mixed with 15 g Trimethoxysilyl terminated polydimethylsiloxane (viscosity ca 2,000 mPa·s @ 25° C.) in a dental mixer at 3500 rpm for 30 seconds leading to a gelled material in about 30 minutes.

### Example 7

199.961 g of dimethylsilanol terminated polydimethylsiloxane having a viscosity of 803 mPa·s at 25° C. was introduced into a plastic receptacle of a DAC 600 FVZ/VAC-P type SpeedMixer™ from Hauschild.

1.290 g of tetra t-butoxy titanium were then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for 2 minutes at 2350 rpm without vacuum, then 2 minutes at 2350 rpm under vacuum and 6 minutes under vacuum without stirring. This mixing regime was repeated a further four times.

After completion of the mixing receptacle, lid and resulting reaction product, were re-weighed to determine weight loss due to the extraction of volatile alcohols.
Initial weight was 277.524 g
Final weight was 276.470 g.
Weight loss=1.054 g
   The resulting loss of 1.054 g in weight again accounts for approximately 93.8% of the alcohol content extractable as a by-product of the reaction between the titanate catalyst (ingredient 1) and the polymer (ingredient 2). The calculated Si—OH/Ti molar ratio was about 7.1:1 assuming an average molecular weight of the polymer of about 14,800.

### Example 8: Partially Trimethylsilyl Terminated OH Terminated PDMS

In this example component (a) was prepared with the first, second and third ingredients. 200 g of a polydimethylsiloxane having 12.5 mol % trimethylsilyl and 87.5 mol % of dimethylsilanol end groups (viscosity of 12,225 mPa·s @ 25° C.) and 0.217 g of tetraisopropoxy titanium was introduced into a plastic receptacle of a DAC 600 FVZ/VAC-P type SpeedMixer™ from Hauschild. A lid was placed on the receptacle and the initial weight of the ingredients, the receptacle and the lid were weighed together. The mixture was mixed in a speedmixer for 4 minutes at 2350 rpm under vacuum and then left for 6 minutes under vacuum without mixing. This procedure of mixing was repeated twice.

After completion of the above mixing regime the resulting reaction product, receptacle and lid were re-weighed to determine weight loss due to the extraction of volatile alcohols. The weight loss was determined to be=0.242 g. The resulting loss of 0.41 g in weight accounts for approximately 100% of the alcohol content extractable as a by-product of the reaction between the titanate catalyst (the first ingredient) and the polymer (the second ingredient).

The viscosity of the reaction product generated via the above process was determined to be 69,545 mPa·s with an Anton Paar MCR 302 rheometer using a rotational 25 mm plate probe at 25° C. and a shear rate of 1 s⁻¹.

30 g of here above prepared product was used to make part A of example 8a adding water parts as mentioned in the table here below using a dental mixer for 30 s at 3500 rpm. 15 g of the preparation was mixed with 15 g of part B in a dental mixer for 30 s at 3500 rpm. The gel time using the same method as previously described was 19 minutes which is much faster than the previously described comparatives.

### Comp. Ex. 1

Usually zirconates function very similarly to titanates but in this instance unexpectedly repeating the process herein with zirconates failed to produce an analogous zirconium reaction product.

200.13 g of dimethylsilanol terminated polydimethylsiloxane having a viscosity of 803 mPa·s at was introduced into a plastic receptacle of a DAC 600 FVZ/VAC-P type SpeedMixer™ from Hauschild.

1.345 g of zirconium (IV) n-butoxide 80% in butanol was then added into the dimethylsilanol terminated polydimethylsiloxane. A lid was placed on the receptacle and the initial weight of the ingredients, the receptacle and the lid were weighed together.

The ingredients were then mixed in a DAC 600 FVZ/VAC-P type SpeedMixer™ from Hauschild for 6 minutes at 2350 rpm under vacuum. This procedure of mixing was repeated 4 times.

After completion of the above mixing regime the receptacle, lid and resulting reaction product, were re-weighed to determine weight loss due to the extraction of volatile alcohols.
Initial weight was 277.744 g g
Final weight was 277.567 g
Weight loss=0.177 g

The resulting loss of 0.177 g is attributed to the butanol solvent from the zirconium catalyst. The initial viscosity of the material was determined to be 1050 mPa·s as measured using a Modular Compact Rheometer (MCR) 302 from Anton Paar GmbH of Graz, Austria with a 25 mm diameter rotational plate with a gap of 0.3 mm at a shear rate of 1 s⁻¹.

This viscosity is only slightly more than the initial viscosity of the linear or branched polydiorganosiloxane, which is an indication that no reaction occurred.

Cured Silicone Compositions Using the Titanium-Based Reaction Product Made in Example 1 Above as Catalyst and Polymer

As previously indicated, the titanium-based reaction product described herein functions as a catalyst in or as a curing agent for curing condensation curable silicone compositions and furthermore, the titanium-based reaction product may additionally replace a proportion or even all the standard silicone polymer utilised in such compositions given the chemically available silanol groups (Si—OH) on the terminal positions enabling the titanium-based reaction product herein to participate in the cure process of the silicone composition. The following Table provides the details of a series of compositions prepared using the titanium-based reaction products of the above examples as catalyst and polymer. These are provided merely as evidence of the suitability of the titanium-based reaction product disclosed herein being successful in these roles. The ability of the titanium-based reaction products of the above examples to cure the compositions in the following Tables can be seen from the gel times or non-flow times provided. The amount of each ingredient is provided in parts by weight in each example unless otherwise indicated.

### Mixing Method

The mixtures were prepared using a SpeedMixer™ DAC 150 FV from Hauschild & Co. KG Germany. The two parts of a two-part composition herein, referred to as Part A and Part B were prepared separately in accordance with Table 1. Part A was the titanium-based reaction product prepared in Example 1 above with the respective ingredients for each part being added to reach 30 g in total at the end of the process and were then mixed for a period of 30 seconds at 3500 revolutions per minute (rpm). Part A and Part B were then mixed together, in a 1:1 weight ratio for a further 30 seconds at 3500 rpm and subsequently the non-flow time for each sample prepared was determined using the following procedure.

### Non-Flow Time

For the purpose of these examples, non-flow time was a manual assessment process at room temperature between 23-25° C. and at 50% relative humidity (RH). The values identified in Table 1 were the time at which point the material stops flowing by visual inspection when the container is inclined by 90° (i.e., vertically).

TABLE 1a
Non-flow times of Several compositions using the Example
1 titanium-based reaction product as catalyst and linear
or branched polydiorganosiloxane parts by weight)

| | Ex. 1a | Ex. 1b | Ex. 1c | Ex. 1d |
|---|---|---|---|---|
| Part A | | | | |
| Example 1 reaction product | 100 | 100 | 100 | 100 |
| Part B | | | | |
| Cross-linker 1 | 100 | 100 | 100 | 100 |
| Water | 0.11 | 0.17 | 0.40 | |
| Non-flow time (min) | 11 | 8 | 5 | 300 |

Cross-linker 1 (in Wt. %) is trimethoxysilyl terminated polydimethylsiloxane (viscosity ca 2,000 mPa·s).

In the following case, compositions were made by mixing 30 g of part A with the respective weight of part B as described in the following table. Part A and part B were mixed 30 seconds at 3500 rpm in a dental mixer and the gel time was determined as described herein.

In the formulations depicted in Table 1b there are two sources for water, the water added in the part B composition but also water present in the fillers when introduced into the composition.

TABLE 1b
Non-flow times of Several compositions containing standard fillers
using the Example 1 titanium-based reaction product as catalyst
and linear or branched polydiorganosiloxane (parts by weight)

| Ingredients | Ex. 1e | Ex. 1f | Ex. 1g | Ex. 1h |
|---|---|---|---|---|
| Part A | | | | |
| Example 1 reaction product | 100.3 | 100.3 | 100.3 | 100.3 |
| Aerosil ™ R 974 | 16.7 | | | 26.7 |
| Winnofil ™ SPM | | 52.18 | | |
| Fumed Silica CAB-O-SIL ™ | | | 10 | |
| LM 150 | | | | |
| Part B | | | | |
| Trimethoxysilyl terminated | 100 | 100 | 100 | 100 |
| polydimethylsiloxane (viscosity | | | | |
| ca 2,000 mPa · s) | | | | |
| Water | 0.23 | 0.23 | 0.23 | 0.23 |
| Non flow time | 10 min | 13 min | 90 min | 20 min |

Aerosil™ R 974 is a hydrophobic fumed silica treated with dimethyldichlorosilanes based on a hydrophilic fumed silica with a specific surface area of 200 m 2/g (supplier information) commercially available from Evonik. WINNOFIL™ SPM is an ultrafine coated precipitated calcium carbonate commercially available from Imerys. CAB-O-SIL™ LM-150 is an untreated, low surface area, hydrophilic fumed silica commercially available from the Cabot Corporation.

### Cured Silicone Compositions Using the Titanium-Based Reaction Product Made in Example 1 Above as Catalyst and Polymer

In these examples, the above Example 2 titanium-based reaction product was used as the catalyst/linear or branched polydiorganosiloxane and was mixed with standard silane cross-linkers and it can be seen that short gel times were achieved, irrespective of the cross-linker.

### Gel Time

Gel time is defined as the time at which the storage modulus G′ and the loss modulus G″ coincide. The value of G″/G′ is sometimes referred to as tan δ and the gel point is to be understood to be when tan δ=G″/G′=1. The measurements of G′ and G″ were undertaken using the aforementioned Modular Compact Rheometer (MCR) 302 from Anton Paar GmbH of Graz, Austria using a 25 mm diameter rotational plate with a gap of 0.3 mm.

As soon as tan δ=G″/G′ is equal to (or less than) 1 the curing material is considered to have gelled. Unless otherwise indicated these tests were undertaken at a temperature of 25° C.

The uncured material is placed in the Modular Compact Rheometer between two plates separated by a gap of 0.3 mm. The upper plate was typically 25 mm in diameter and the excess of material is removed with a tissue or a spatula. A rotary oscillation is carried out at an angular frequency of 10 rad/s and a shear strain of 1%. A measurement is made every 30 seconds initially with a descending logarithmic ramp. For example, after 1500 points, the measurements are carried out every 17.5 min. The gel time is defined as the interval of time between when the product was mixed and when the storage modulus G′ and loss modulus G″ coincide, i.e., when tan δ is equal to or first less than (≤) 1 on the rheometer. This time is roughly equivalent to the time the material under test stops flowing freely.

TABLE 2a

| | Ex. 2a | Ex. 2b | Ex. 2c | Ex. 2d | Ex. 2e |
|---|---|---|---|---|---|
| Part A | | | | | |
| Example 2 reaction | 101.75 | 101.75 | 101.75 | 101.75 | 101.75 |
| product | | | | | |
| water | 0.8 | 0.8 | 0.8 | 0.8 | 0.8 |
| Part B | | | | | |
| Methyltrimethoxysilane | 5.5 | | | | |
| Tetraethoxysilane | | 8.6 | | | |
| 50/50 by weight mixture | | | 10 | | |
| of methyl | | | | | |
| triacetoxysilane and ethyl | | | | | |
| triacetoxysilane | | | | | |
| n-propyl orthosilicate | | | | 11 | |
| Methyltrioximinosilane | | | | | 12.2 |
| Gel time G′/G″ at 25° | 9.2 | 26 | 29 | 69 | 110 |
| C. (min) | | | | | |

In Table 3a the titanium-based reaction product of Example 4 above is used as the catalyst and replaces the need for polymer.

TABLE 3a

| | Ex 4a | Ex 4b |
|---|---|---|
| Part A | | |
| Example 4 reaction product | 100.4 | 100.4 |
| Water | 0 | 0.14 |
| Part B | | |
| Trimethoxysilyl terminated polydimethylsiloxane | Mixing | Mixing |
| (viscosity ca 2,000 mPa · s) | ratio 1:1 | ratio 1:1 |
| Gel time G′/G″ at 25° C. (min) | 30 | 18 |

Part A and part B were mixed after the Example 4 reaction product (i.e., part A) had been aged for 28 days at room temperature and 50% relative humidity (RH) exposure.

Part B was prepared by mixing stepwise ingredients of the table directly after their addition in a speedmixer for 30 seconds at 2300 rpm.

The compositions used in the following examples were made by mixing part A and part B together in a speedmixer. The part A and Part B were introduced into a speedmixer and were then mixed for four periods of 30 seconds at a speed of 2300 revolutions per minute (rpm). The resulting mixture was poured into an aluminium cup and onto a glass substrate surface and left to cure for 7 days at room temperature.

1. A method for the preparation of a titanium-based reaction product said method comprising the steps of:
(i) mixing a first ingredient, an alkoxy titanium compound having from 2 to 4 alkoxy groups with a second ingredient, a linear or branched polydiorganosiloxane having at least two terminal silanol groups per molecule and a viscosity of from 30 to 300000 mPa·s at 25° C.;
(ii) enabling the first and second ingredients to react together by stirring under vacuum to form a reaction product; and
(iii) collecting the reaction product of step (ii).

2. The method for the preparation of a titanium-based reaction product in accordance with claim 1, wherein the first ingredient is Ti(OR)₄, Ti(OR)₃R¹, Ti(OR)₂R¹₂ or a chelated alkoxy titanium molecule where there are two alkoxy (OR) groups present and a chelate bound twice to the titanium atom; where R is a linear or branched alkyl group having from 1 to 20 carbons and each R¹ may be the same or different and is selected from an alkyl group, an alkenyl group or an alkynyl group in each case having up to 10 carbons.

3. The method for the preparation of a titanium-based reaction product in accordance with claim 1, wherein the polydialkylsiloxane having at least two terminal silanol groups per molecule of the second ingredient is a dialkylsilanol terminated polydimethylsiloxane.

4. The method for the preparation of a titanium-based reaction product in accordance with claim 1, wherein the second ingredient has a viscosity of between 70 and 20,000 mPa·s at 25° C.

5. The method for the preparation of a titanium-based reaction product in accordance with claim 1, wherein the reaction takes place under vacuum to remove at least 50 wt. %, of the total amount of alcoholic by-products generated during the reaction.

6. The method for the preparation of a titanium-based reaction product in accordance with claim 1, wherein the titanium-based reaction product has a viscosity of between 500 and 1,000,000 mPa·s.

7. The method for the preparation of a titanium-based reaction product in accordance with claim 1, wherein a third ingredient, a polydialkylsiloxane having one terminal silanol per molecule, is introduced in step (i).

8. The method for the preparation of a titanium-based reaction product in accordance with claim 1, wherein in step (i) the first ingredient is added into the second ingredient.

9. The method for the preparation of a titanium-based reaction product in accordance with claim 1, wherein in step (i) the second ingredient is added into the first ingredient.

10. The method for the preparation of a titanium-based reaction product in accordance with claim 1, wherein the main reaction products, when the first ingredient is Ti(OR)₄, is a mixture of
(RO)ₙTi(OSiR²₂)ₙ—OH)₄₋ₙ (2)
where R is a linear or branched alkyl group having from 1 to 20 carbons, each R² is independently an organic group, n is 0, 1 or 2, and m is an integer indicative of the viscosity of the second ingredient.

11. The method for the preparation of a titanium-based reaction product in accordance with claim 1, wherein the main reaction products, when the first ingredient is substantially Ti(OR)₃R¹, is a mixture of
R¹(RO)ₐTi((OSiR²₂)ₘ—OH)₃₋ₐ (4)
where R is a linear or branched alkyl group having from 1 to 20 carbons, each R¹ may be the same or different and is selected from an alkyl group, an alkenyl group or an alkynyl group in each case having up to 10 carbons, each R² is independently an organic group, a is 0 or 1, and m is an integer indicative of the viscosity of the second ingredient.

12. A titanium-based reaction product which is prepared by the method of claim 1.

13. A titanium-based reaction product obtained or obtainable by the method in accordance with claim 1.

14. A condensation curable silicone elastomer composition comprising the titanium-based reaction product of claim 12.

15. A condensation curable silicone elastomer composition comprising the titanium-based reaction product of claim 13.
